(19) United States
(12) Patent Application Publication
(10) Pub. No.: US 2024/0226958 A1
(43) Pub. Date: Jul. 11, 2024

(54) MULTI-MODE PAINT CURING SYSTEM FOR FULL VEHICLE AND PARTS

(71) Applicant: GM GLOBAL TECHNOLOGY OPERATIONS LLC, Detroit, MI (US)

(72) Inventors: Hua-tzu FAN, Troy, MI (US); Xiang ZHAO, Novi, MI (US); John Patrick SPICER, Plymouth, MI (US); Marcel James ISROW, Sterling Heights, MI (US); Lisa M. ALBAUGH, Frankfort, IN (US)

(21) Appl. No.: 18/095,432

(22) Filed: Jan. 10, 2023

(51) Int. Cl. B05D 3/04; B05D 3/02; B05D 3/06; B25J 11/00

(52) U.S. Cl. CPC B05D 3/0413; B05D 3/0209; B05D 3/0263; B05D 3/066; B25J 11/00

(57) ABSTRACT

A paint curing system is provided. The paint curing system includes a robot arm, a first light, a lamp panel, and a control module. The robot arm includes a first end and a second end that opposes the first end. The first light is disposed at the second end of the robot arm and is configured to cure paint on a first panel of a vehicle. The lamp panel is positioned adjacent to the vehicle and includes a second light that is configured to cure paint on a second panel of the vehicle. The control module configured to actuate the robot arm and position the first light relative to the first panel of the vehicle, selectively turn on and off the first light, and selectively turn on and off the second light.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to painting, and more particularly to a multi-mode paint curing system for full vehicle and parts.

During manufacture of a vehicle, paint may be applied to panels of the vehicle. More specifically, paint may be applied to an exterior surface and an interior surface of the panel. Examples of such panels include a door frame, a fuel door, and a liftgate of the vehicle. Various types of paint may be used. One type of paint is curable paint.

### SUMMARY

An example paint curing system includes a robot arm, a first light, a lamp panel, and a control module. The robot arm includes a first end and a second end that opposes the first end. The first light is disposed at the second end of the robot arm and is configured to cure paint on a first panel of a vehicle. The lamp panel is positioned adjacent to the vehicle and that includes a second light configured to cure paint on a second panel of the vehicle. The control module is configured to actuate the robot arm and position the first light relative to the first panel of the vehicle. The control module is configured to selectively turn on and off the first light, and selectively turn on and off the second light.

In one example, the first light includes at least one of an ultraviolet (UV) light and an infrared (IR) light and the second light includes at least one of a UV light and an IR light.

In one example, the UV light is a UV light emitting diode (LED) light.

In one example, the first light includes at least two of a UV-A light, a UV-B light, a UV-C light, and an IR light.

In one example, the control module is configured to selectively adjust an intensity of the first light and an intensity of the second light.

In one example, the control module is configured to selectively set a first period that the first light will be on and output light to the first panel, and a second period that the second light will be on and output light to the second panel.

In one example, the first light includes multiple first lights, and the control module is configured to control each of the multiple first lights individually. The second light includes multiple second lights, and the control module is configured to control each of the multiple second lights individually.

In one example, the lamp panel includes multiple lamp panels formed in an arch shape around the vehicle.

In one example, the lamp panel is formed in at least one of a rectangular shape, a semi-circular shape, and a curved shape.

An example paint curing system includes a robot arm, a first light, a lamp panel, a heater, and a control module. The robot arm includes a first end and a second end that opposes the first end. The first light is disposed at the second end of the robot arm and is configured to cure paint on a first panel of a vehicle. The lamp panel is positioned adjacent to the vehicle and includes a second light that is configured to cure paint on a second panel of the vehicle. The heater is configured to supply heated air to the vehicle. The control module is configured to actuate the robot arm and position the first light relative to the first panel of the vehicle, selectively turn on and off the first light and the second light, and selectively turn on and off the heater.

In one example, the vehicle is disposed within a room and the heater is disposed outside of the room and configured to supply heated air into the room.

In one example, a first duct extends between the room and the heater and is configured to carry air from the room to the heater.

In one example, a second duct extends between the heater and the room and is configured to carry heated air from the heater to the room. The second duct is attached to a sidewall of the room and the second duct is attached to a floor of the room.

In one example, the second duct includes a first branch positioned on a first side of the vehicle and a second branch positioned on a second side of the vehicle.

In one example, interior surfaces of the room are covered using a UV light shielding film.

In one example, the first light and the second light each include a plurality of lights having a same wavelength.

In one example, the first light and the second light each include a plurality of lights having more than one different wavelength.

An example paint curing system includes a robot arm, a first light, lamp panels, an actuator, and a control module. The robot arm includes a first end and a second end that opposes the first end. The first light is disposed at the second end of the robot arm and is configured to cure paint on a first panel of a vehicle. Lamp panels are positioned adjacent to the vehicle, and each include a second light that is configured to cure paint on a second panel of the vehicle. The actuator is configured to move the lamp panels to a first position, to a second position, and to positions between the first and second positions. The control module is configured to actuate the robot arm and position the first light relative to the first panel of the vehicle, selectively turn on and off the first light and the second lights and actuate the actuator.

In one example, a first distance between the lamp panels and the second panel of the vehicle when the lamp panels are in the first position is less than a second distance between the lamp panels and the second panel when the lamp panels are in the second position.

In one example, the actuator is configured to adjust a shape of the lamp panels based on a shape of the second panel of the vehicle.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example paint curing system;

FIG. 2 is a front view of an example paint curing system;

FIG. 3 is a perspective view of an example lamp panel formed in a linear shape;

FIG. 4 is a perspective view of an example lamp panel formed in a semi-circular shape;

FIG. 5 is a perspective view of an example lamp panel formed in a curved shape;

FIG. 6 is a perspective view of an example lamp panel including groupings of lights;

FIG. 7 is a front view of another example lamp panel including lights having different wavelengths;

FIG. 8 is a front view of an example paint curing system including adjusters; and

FIG. 9 is a front view of an example paint curing system including a heater.

In the drawings, reference numbers may be reused to identify similar and/or identical elements.

### DETAILED DESCRIPTION

Panels of a vehicle may be painted and cured during a production process of the vehicle. Examples of such panels include interior panels of the vehicle and exterior panels of the vehicle. In one example, the panels may be cured using a cure oven after the panel is painted. While the panels are disposed within the cure oven, the cure oven is configured to raise a temperature of the panels to a target temperature for a target duration of time. In one example, the target temperature may be about 250 degrees Fahrenheit (OF) and the target duration of time may be about 30 minutes. However, use of the cure oven requires consumption of energy such as natural gas or electricity, which is costly and increases a carbon footprint of the production process of the vehicle.

In another example, the panels of the vehicle may be cured using an ultraviolet (UV) lamp that is stationary. The UV lamp may apply UV light onto the panel for about 2 minutes. Compared against using cure ovens, the panels may be cured in less time and less energy is consumed using the UV lamp.

However, the UV lamp may not cure some portions of the panels because of a poor line of sight between the UV lamp and such portions of the panel. In one example, this may be because of the positioning and geometry of the panel in relation to the UV lamp. Hence, one or more portions of the panels may be left uncured.

In light of the above, the present application involves lamp panels and robot-mounted lights for curing paint on a full body of the vehicle using light. FIG. 1 is a functional block diagram of an example paint curing system.

With reference to FIG. 1, a paint curing system 100 may include a control module 102, one or more robots 104, and one or more lamp panels 106. The control module 102 is configured to operate the robots 104 and the lamp panels 106.

First lights 108 may be disposed at one end of the robot 104. The robot 104 may have a suitable number of degrees of freedom (DOF), such as 6 DOF or higher. The control module 102 is configured to actuate the robot 104 and achieve a target position of the first lights 108 relative to a first panel 110 of a vehicle 112 to cure paint on the first panel 110. In one example, the first panel 110 is an interior panel of the vehicle 112. The control module 102 is configured to selectively turn on one or more of the first lights 108. The control module 102 individually controls a light output frequency of each of the first lights 108, a light intensity of each of the first lights 108, and a period of time that the first lights 108 are on and output light to the first panel 110. The first lights 108 may include UV lights, UV light emitting diode (LED) lights, infrared (IR) lights, another suitable type of lights, or a combination thereof.

The lamp panels 106 may include second lights 114. The lamp panels 106 may be secured to a stationary structure (e.g., a ceiling, a sidewall). The lamp panels 106 may be positioned to output light onto the vehicle 112, and more specifically, onto one or more second panels 116 of the vehicle 112. In one example, the second panels 116 are exterior panels of the vehicle 112. The control module 102 is configured to selectively turn on one or more of the second lights 114, such as to cure paint on the second panels 116. The control module 102 individually controls a light output frequency of each of the second lights 114, a light intensity of each of the second lights 114, and a period of time that the second lights 114 are on and output light to the second panels 116. The second lights 114 may include UV lights, UV LED lights, IR lights, another suitable type of lights, or a combination thereof.

FIG. 2 is a front view of an example paint curing system 120. The paint curing system 120 may include example robots (e.g., 104) and example lamp panels 124 (e.g., 106) disposed in a room 126.

The room 126 includes a ceiling 128, sidewalls 130, and a floor 132. Interior surfaces of the room 126, paint tubing, paint containers, and paint storage tanks may be covered in a UV light shielding film, such as yellow-dyed cellulose triacetate film, such as to prevent premature curing of the paint. A vehicle 134 may be disposed within the room 126. The room 126 may be used as a paint spray booth for applying paint to panels of the vehicle 134 and for curing of paint of panels of the vehicle 134. The vehicle 134 may be positioned on the floor 132, on a vehicle stand 135, or in another suitable location.

The robots may include a first robot 136 and a second robot 138. The first robot 136 may be disposed on a first lateral side 140 of the vehicle 134 and the second robot 138 may be disposed on a second lateral side 144 of the vehicle 134. Each of the first and second robots 136, 138 have a suitable number of DOF, such as 6 DOF or higher.

Each of the first and second robots 136, 138 may include a base 146 and a robot arm 148. The base 146 may be positioned on the floor 132, on a robot stand 150, or in another suitable location. The robot arm 148 extends between a first end 152 and a second end 154 that opposes the first end 152. The first end 152 of the robot arm 148 may be attached to the base 146. The second end 154 of the robot arm 148 may be attached to first lights 156 (e.g., 108) that are configured to cure paint. The robot arm 148 may move such that the first lights 156 output light to an interior panel of the vehicle 134, or another suitable panel of the vehicle 134. The first lights 156 may include UV lights, UV LED lights, IR lights, another suitable type of lights, or any combination thereof.

Each of the lamp panels 124 include second lights 160 (e.g., 114) that are configured to cure paint. The second lights 160 are positioned to output light toward the vehicle 134. The lamp panels 124 may be attached to the ceiling 128 of the room 126, sidewalls 130 of the room 126, both the ceiling 128 and sidewalls 130 of the room 126, or another suitable structure. In the illustrated example, six lamp panels 124 are attached to a first portion 162 of the ceiling 128, six lamp panels 124 are attached to a second portion 164 of the ceiling 1128, six lamp panels 124 are attached to a first one 166 of the sidewalls 130, and six lamp panels 124 are attached to a second one 168 of the sidewalls 130. Accordingly, the lamp panels 124 form an arch shape over and around the vehicle 134. While examples of numbers of panels and arrangement shape are provided, the present application is also applicable to other numbers of lamp panels 124 which can be attached to other suitable portions of the room 126 and arrangements of the lamp panels in other suitable shapes.

In some configurations of the lamp panels, a lamp panel may be formed in a rectangular configuration. FIG. 3 is a perspective view of an example lamp panel 170 formed in a rectangular shape.

The lamp panel 170 may include second lights 172 and a lamp housing 174. In the illustrated example, the lamp housing 174 is formed in a substantially rectangular shape. Six second lights 172 are disposed on one side 176 of the lamp housing 174. The second lights 172 are positioned in a substantially linear arrangement along one line. However, the present application is also applicable to other shapes of the lamp panel 170, other numbers of second lights 172, and other arrangements of the second lights 172.

In some configurations of the lamp panels, a lamp panel may be formed in a semi-circular configuration. FIG. 4 is a perspective view of an example lamp panel 180 formed in a semi-circular shape.

The lamp panel 180 may include second lights 182 and a lamp housing 184. In the illustrated example, the lamp housing 184 is formed in a substantially semi-circular shape. The semi-circular shape may aid in curing paint on multiple sides of panels of the vehicle 134, such as an A-pillar. The semi-circular shape allows for uniform UV radiation to different panels of the vehicle 134. The second lights 182 are disposed on an inner side 186 of the lamp housing 184. In other words, the second lights 182 may face each other and output light radially inwardly toward a center of the semi-circular shape. The second lights 182 are spaced apart from each other and positioned in a single plane. However, the present application is also applicable to other shapes of the lamp panel 180, other numbers of the second lights 182, and other arrangements of the second lights 182.

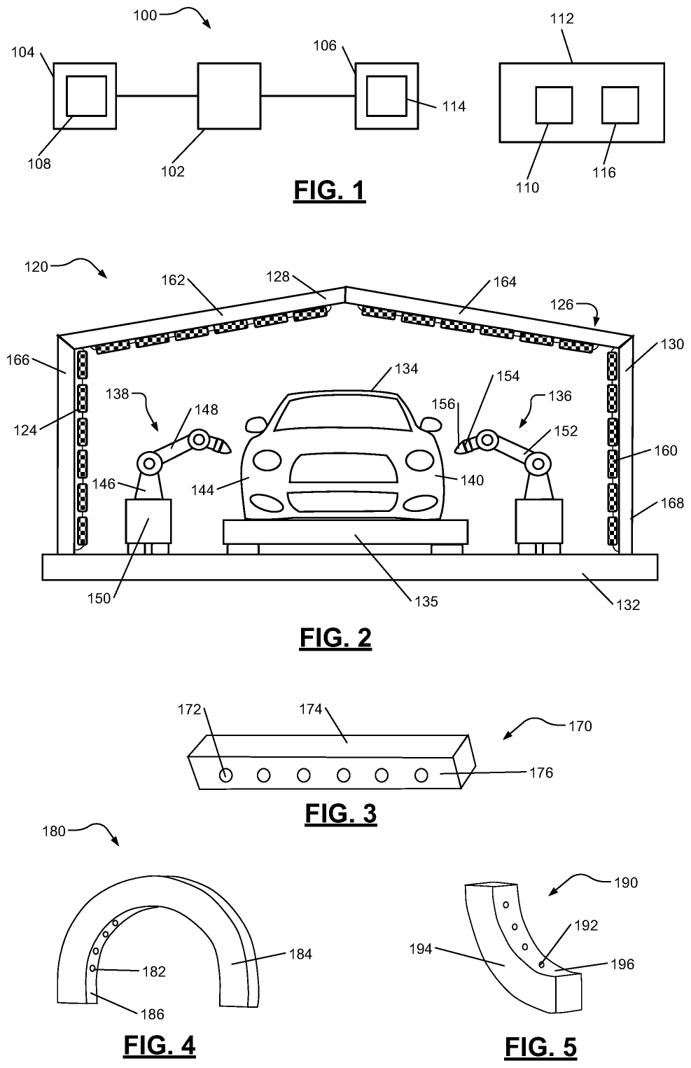

In some configurations of the lamp panels, a lamp panel may be formed in a curved (e.g., quarter circle) configuration. FIG. 5 is a perspective view of an example lamp panel 190 formed in a curved configuration.

The lamp panel 190 may include second lights 192 and a lamp housing 194. In the illustrated example, the lamp housing 194 is formed in a substantially curved (e.g., quarter circle) shape. The curved shape may aid in curing paint that is applied to panels (e.g., curved) of the vehicle 134, such as a vehicle hood. The second lights 192 are disposed on an inner side 196 of the lamp housing 194. The second lights 192 include four lights that are spaced apart from each other and positioned in a single (e.g., vertical) plane. However, the present application is also applicable to other shapes of the lamp panel 190, other numbers of second lights 192, and other arrangements of the second lights 192.

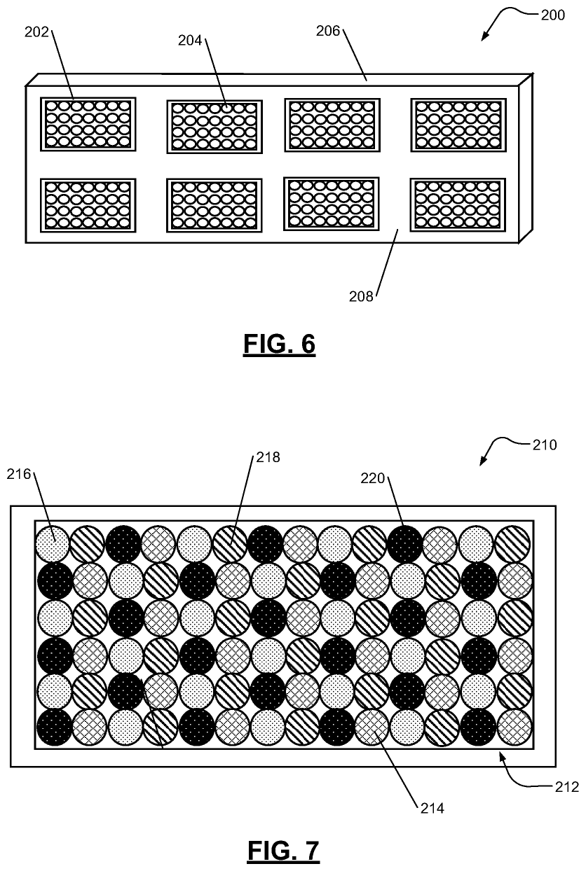

In some configuration of the lamp panels, a lamp panel may include groups of second lights. FIG. 6 is a perspective view of an example lamp panel 200 including a plurality of groups 202 of second lights 204.

The lamp panel 200 may include a lamp housing 206 and the second lights 204. The lamp housing may be formed in a rectangular shape or in another suitable shape. The second lights 204 may be disposed on one side 208 of the lamp housing 206.

The second lights 204 are arranged in the plurality of groups 202. In the illustrated example, the plurality of groups 202 includes eight groups that are arranged into two rows and four columns. However, the plurality of groups 202 may include another suitable number of groups, and the plurality of groups 202 may be arranged in another suitable configuration.

The control module 102 is configured to selectively turn on and off each second light 204 individually. In one example, the control module 102 may selectively turn on and off each group 202 of second lights 204 individually. In another example, the control module 102 may selectively turn on and off some second lights 204 in one of more of the groups 202.

The control module 102 is configured to control the light output frequency of the second lights 204, the light intensity of the second lights 204, and the period of time that the second lights 204 are on and output light. In one example, the control module 102 may selectively control each group 202 of second lights 204 individually, such as at varying light intensities for each group 202 of second lights 204. In another example, the control module 102 may individually control some second light 204 in one of more of the groups 202, such as at a constant light intensity for each second light 204.

In some configuration of the lamp panels, a lamp panel may include second lights having two or more different light wavelengths. FIG. 7 is a front view of an example lamp panel 210 including a plurality of second lights 212.

The plurality of second lights 212 may include IR lights 214, UV-A lights 216, UV-B lights 218, UV-C lights 220, or a combination of two or more of the above. IR lights 214 may have a light wavelength ranging from about 780 nanometers (nm) to about 1 millimeter (mm). UV-A lights 216 may have a light wavelength ranging from about 315 nm to about 400 nm. UV-B lights 218 may have a light wavelength ranging from about 280 nm to about 315 nm. UV-C lights 220 may have a light wavelength ranging from about 100 nm to about 280 nm.

In various implementations, the plurality of second lights 212 may include a combination of two or more of IR, UV-A, UV-B, and UV-C lights 214, 216, 218, 220. The control module 102 is configured to selectively turn on and off one or more sets of UV lights (i.e., UV-A, UV-B, UC-V) based on the paint applied. For example, the different UV light wavelengths may be used to cure different types of paint or different compositions of the same type of paint. For example, a primer may be cured using UV-C lights 220, while another type of paint (e.g., a clear coat) may be cured using UV-A light 216 and/or UV-B lights 218. The control module 102 is configured to selectively turn on one or more of the IR lights 214 to cure the paint, such as when heat is required.

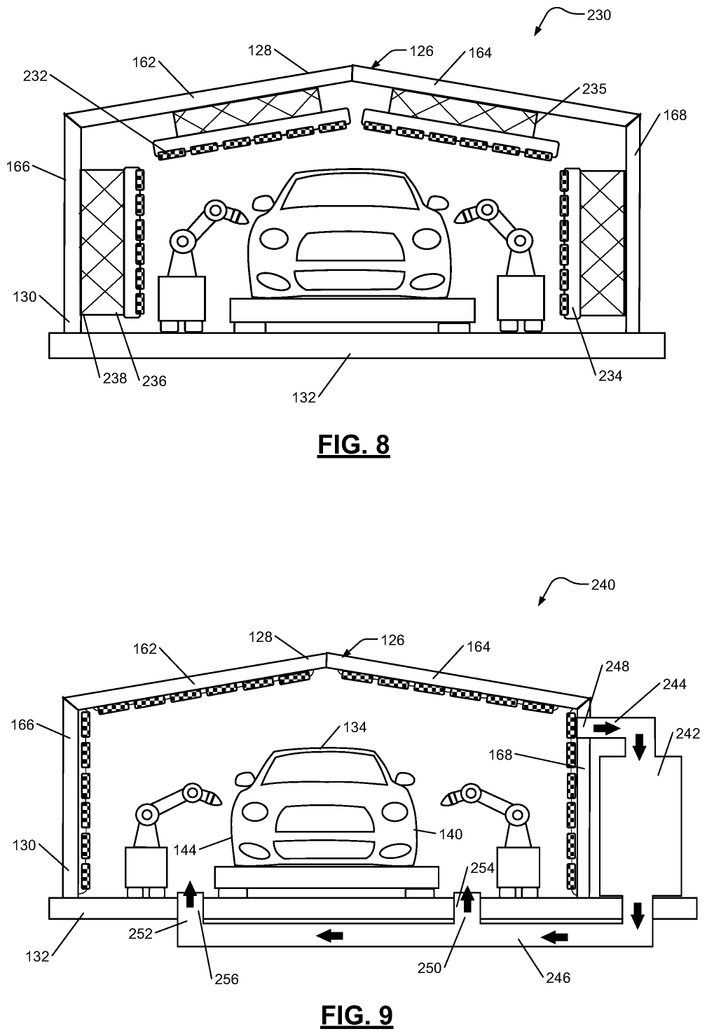

In some configurations of the paint curing system, a paint curing system may include movable lamp panels. FIG. 8 is a front view of an example paint curing system 230. The paint curing system may include sets of lamp panels 232, lamp housings 234, and actuators 235.

Each set of lamp panels 232 is attached to the lamp housing 234. In the illustrated example, one set of lamp panels 232 includes six lamp panels. The sets of lamp panels 232 are attached to the first portion 162 of the ceiling 128, to the second portion 164 of the ceiling 128, to the first one 166 of the sidewalls 130, and to the second one 168 of the sidewalls 130. However, the sets of lamp panels 232 may be attached to another suitable portion of the room 126.

Each actuator 235 may include a third end 236 and a fourth end 238 that is opposite the third end 236. The third end 236 of the actuator 235 is attached to the lamp housing 234. The fourth end 238 of the actuator 235 is attached to the respective sidewall 130 or ceiling 128 of the room 126. The actuator 235 is configured to move to a first position, to a second position (shown in FIG. 8), and to positions between the first and second positions. The actuator 235 moves the lamp housing 234 and the lamp panels 232 when the actuator 235 moves. For example, the actuator 235 may move the lamp housing 234 and the lamp panels 232 to a position closer to the vehicle 134 when the actuator 235 is in the second position. In another example, the actuator 235 may change a shape of the lamp housing 234 and the lamp panels 232, such as to contour the lamp panel 232 to match a shape of the vehicle 134 (or a panel of the vehicle 134). In this example, the lamp housing 234 may, for example, be made of a flexible material or include one or more hinging portions. Movement of the lamp panels 232 allows for more efficient and uniform paint curing of the vehicle 134.

In some configurations of the paint curing system, a paint curing system may include a heater. FIG. 9 is a front view of an example paint curing system 240 including a heater 242.

The paint curing system 240 may include a first duct 244, the heater 242, and a second duct 246. The first duct 244 extends between the second one 168 of the sidewalls 130 and the heater 242. The first duct 244 may be arranged in fluid communication with the room 126 via a first opening 248 in the first one 166 of the sidewalls 130. However, the first duct 244 may be disposed in another suitable location. Air may flow from the room 126 to the heater 242 using the first duct 244. The heater 242 may be positioned beside the second one 168 of the sidewalls 130 of the room 126. In one example, the heater 242 includes a furnace. In another example, the heater 242 includes an electrically resistive heater.

The second duct 246 extends between the heater 242 and the floor 132. The second duct 246 may be arranged in fluid communication with the room 126 using openings in the floor 132. Heated air flows from the heater 242 and into the room 126 via the second duct 246. In the illustrated example, the second duct 246 includes a first branch 250 and a second branch 252. The first branch 250 is arranged in fluid communication with the room 126 using a first opening 254 in the floor 132. The second branch 252 is arranged in fluid communication with the room 126 using a second opening 256 in the floor 132. The first branch 250 and the first opening 254 may be positioned near the first lateral side 140 of the vehicle 134. The second branch 252 and the second opening 256 may be positioned near the second lateral side 144 of the vehicle 134. However, the second duct 246 may be disposed in another suitable location and may be arranged in another suitable configuration.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A paint curing system comprising:
a robot arm including a first end and a second end that opposes the first end;
a first light disposed at the second end of the robot arm and that is configured to cure paint on a first panel of a vehicle;
a lamp panel positioned adjacent to the vehicle and that includes a second light configured to cure paint on a second panel of the vehicle; and
a control module configured to:
actuate the robot arm and position the first light relative to the first panel of the vehicle;
selectively turn on and off the first light; and
selectively turn on and off the second light.

2. The paint curing system of claim 1, wherein the first light includes at least one of an ultraviolet (UV) light and an infrared (IR) light and the second light includes at least one of a UV light and an IR light.

3. The paint curing system of claim 2, wherein the UV light is a UV light emitting diode (LED) light.

4. The paint curing system of claim 1, wherein the first light includes at least two of a UV-A light, a UV-B light, a UV-C light, and an IR light.

5. The paint curing system of claim 1, wherein the control module is configured to selectively adjust an intensity of the first light and an intensity of the second light.

6. The paint curing system of claim 1, wherein the control module is configured to selectively set:
a first period that the first light will be on and output light to the first panel, and
a second period that the second light will be on and output light to the second panel.

7. The paint curing system of claim 1, wherein:
the first light includes multiple first lights, and the control module is configured to control each of the multiple first lights individually; and
the second light includes multiple second lights, and the control module is configured to control each of the multiple second lights individually.

8. The paint curing system of claim 1, wherein the lamp panel includes multiple lamp panels formed in an arch shape around the vehicle.

9. The paint curing system of claim 1, wherein the lamp panel is formed in at least one of a rectangular shape, a semi-circular shape, and a curved shape.

10. A paint curing system comprising:
a robot arm including a first end and a second end that opposes the first end;
a first light disposed at the second end of the robot arm and that is configured to cure paint on a first panel of a vehicle;
a lamp panel positioned adjacent to the vehicle and that includes a second light configured to cure paint on a second panel of the vehicle;
a heater configured to supply heated air to the vehicle; and
a control module configured to:
actuate the robot arm and position the first light relative to the first panel of the vehicle;
selectively turn on and off the first light and the second light; and
selectively turn on and off the heater.

11. The paint curing system of claim 10, wherein the vehicle is disposed within a room and the heater is disposed outside of the room and configured to supply heated air into the room.

12. The paint curing system of claim 11, further comprising:
a first duct extending between the room and the heater and that is configured to carry air from the room to the heater.

13. The paint curing system of claim 12, further comprising a second duct extending between the heater and the room and that is configured to carry heated air from the heater to the room, wherein the second duct is attached to a sidewall of the room and the second duct is attached to a floor of the room.

14. The paint curing system of claim 13, wherein the second duct includes a first branch positioned on a first side of the vehicle and a second branch positioned on a second side of the vehicle.

15. The paint curing system of claim 11, wherein interior surfaces of the room are covered using a UV light shielding film.

16. The paint curing system of claim 10, wherein the first light and the second light each include a plurality of lights having a same wavelength.

17. The paint curing system of claim 10, wherein the first light and the second light each include a plurality of lights having more than one different wavelength.

18. A paint curing system comprising:
a robot arm including a first end and a second end that opposes the first end;
a first light disposed at the second end of the robot arm and that is configured to cure paint on a first panel of a vehicle;
lamp panels positioned adjacent to the vehicle and that each include a second light configured to cure paint on a second panel of the vehicle;
an actuator configured to move the lamp panels to a first position, to a second position, and to positions between the first and second positions; and
a control module configured to:
actuate the robot arm and position the first light relative to the first panel of the vehicle;
selectively turn on and off the first light and the second lights; and
actuate the actuator.

19. The paint curing system of claim 18, wherein a first distance between the lamp panels and the second panel of the vehicle when the lamp panels are in the first position is less than a second distance between the lamp panels and the second panel when the lamp panels are in the second position.

20. The paint curing system of claim 18, wherein the actuator is configured to adjust a shape of the lamp panels based on a shape of the second panel of the vehicle.
